(19) United States
(12) Patent Application Publication
(10) Pub. No.: US 2026/0150804 A1
(43) Pub. Date: Jun. 4, 2026

(54) PORTABLE SMART PET TOILET

(71) Applicant: Dongguan Xinchongfang Pet Supplies Co., Ltd., Dongguan (CN)

(72) Inventor: Weiqiang ZENG, Dongguan (CN)

(73) Assignee: Dongguan Xinchongfang Pet Supplies Co., Ltd., Dongguan (CN)

(21) Appl. No.: 19/387,853

(22) Filed: Nov. 13, 2025

(30) Foreign Application Priority Data
Nov. 29, 2024 (CN) 202411741012.X

(51) Int. Cl. A01K 1/01

(52) U.S. Cl. CPC A01K 1/011

(57) ABSTRACT

A portable smart pet toilet includes a toilet housing, where a potty is disposed outside the toilet housing, and a first communicating hole is formed in the bottom of the potty; a clean water tank, where the clean water tank is disposed inside the toilet housing and configured to store clean water; a clean water delivery system, where the clean water delivery system is configured to deliver clean water in the clean water tank into the potty; a waste water tank, where the waste water tank is disposed inside the toilet housing and is in communication with the potty by using the first communicating hole; and a sensing system, where the sensing system is disposed in the toilet housing and controlled to be connected to the clean water delivery system.

### CROSS-REFERENCE TO RELATED APPLICATIONS

This application claims priority to Chinese Patent Application No. 202411741012.X, filed on Nov. 29, 2024, the content of which is incorporated herein by reference in its entirety.

### TECHNICAL FIELD

The present disclosure relates to the field of pet toilets, in particular to a portable smart pet toilet.

### BACKGROUND

With social progress and improvement of living standards, more and more pets enter family life. At present, cats and dogs are generally fed indoors in urban households, and pets are fed with fixed-point stool habits through training. Therefore, various pet toilets appear on the market, and traditional pet toilets usually adopt an open design. For example, in cat litter boxes, after excretion is completed, feces of pets are exposed to an indoors environment, and emitted peculiar smell causes specific pollution on indoor air, thereby reducing indoor environment quality. On the market, deodorant cat litter is usually used to collect feces and conceal smell, but regularly manual cleaning is required, so that time and labor are wasted. If the feces are not cleaned in time, the feces accumulated in the toilet and a wet environment may breed a large quantity of pathogenic bacteria to threaten the health of family members, and in a case that cat litter is used for a long time, pet feeding costs may also be increased. The problems urgently need to be solved.

### SUMMARY

Aiming at disadvantages in the prior art, the present disclosure provides a portable smart pet toilet.

The purpose of the present disclosure is realized through the following technical solution.

A portable smart pet toilet includes:
a toilet housing, where a potty is disposed outside the toilet housing, and a first communicating hole is formed in a bottom of the potty;
a clean water tank, where the clean water tank is disposed inside the toilet housing and configured to store clean water;
a clean water delivery system, where the clean water delivery system is configured to deliver clean water in the clean water tank into the potty;
a waste water tank, where the waste water tank is disposed inside the toilet housing and is in communication with the potty by using the first communicating hole; and
a sensing system, where the sensing system is disposed in the toilet housing and controlled to be connected to the clean water delivery system, and the sensing system is configured to sense a pet located in the potty.

By using the foregoing technical solution, when the pet enters the potty for excretion, the sensing system detects the presence of the pet, and sends a signal to the clean water delivery system after confirming an excretion behavior of the pet. After receiving the signal, the clean water delivery system delivers the clean water stored into the clean water tank into the potty, so that pet excreta flows into the waste water tank by using the first communicating hole under covering and flushing effects of the clean water, to complete the process that the pet goes to the toilet and the excreta is flushed immediately. Compared with traditional pet toilets, the pet excreta can be quickly covered and flushed into the closed waste water tank through instant flushing, which can greatly reduce indoor emission of peculiar smell and keeps the potty clean in a wet flushing manner, thereby reducing an opportunity of breeding pathogenic bacteria, and improving indoor environment quality. Moreover, without regularly manual cleaning, functions of automatic flushing and waste water collection are used, thereby reducing frequency and strength of manual cleaning. In addition, the use of cat litter can be avoided, so as to reduce pet feeding costs.

### BRIEF DESCRIPTION OF THE DRAWINGS

FIG. 1 is an integral structural schematic diagram of a portable smart pet toilet in an embodiment of the present disclosure.

FIG. 2 is a structural schematic diagram after a toilet housing of a portable smart pet toilet is removed in an embodiment of the present disclosure.

FIG. 3 is a sectional structural schematic diagram of a portable smart pet toilet in an embodiment of the present disclosure.

FIG. 4 is a sectional schematic diagram of a clean water tank in an embodiment of the present disclosure.

FIG. 5 is an assembly schematic diagram of a waste water tank in an embodiment of the present disclosure.

### DETAILED DESCRIPTION OF THE EMBODIMENTS

The following describes the exemplary embodiments of the present disclosure with reference to the accompanying drawings, which include various details of the embodiments of the present disclosure to facilitate understanding, and should be considered as merely exemplary. Therefore, a person of ordinary skill in the art should recognize that various changes and modifications may be made to the embodiments described herein without departing from the scope and spirit of the present disclosure. Similarly, for clarity and simplicity, the following descriptions omit descriptions of the well-known functions and structures.

It needs to be noted that in the present disclosure, the terms such as “first” and “second” are intended to distinguish between similar objects but do not necessarily indicate a specific order or sequence. It should be understood that the data termed in such a way are interchangeable in proper circumstances, so that this embodiment of the present disclosure described herein can be implemented in other orders than the order illustrated or described herein. The enforcement modes described in the following exemplary embodiments do not represent all enforcement modes which are the same as the present disclosure.

In addition, the term “and/or” in this specification describes only an association relationship for describing associated objects and represents that three relationships may exist. For example, A and/or B may represent the following three cases: only A exists, both A and B exist, and only B exists. In addition, unless otherwise specified, the character “/” in this specification generally indicates an “or” relationship between the associated objects.

With reference to the accompanying drawings, a portable smart pet toilet according to the present disclosure is described.

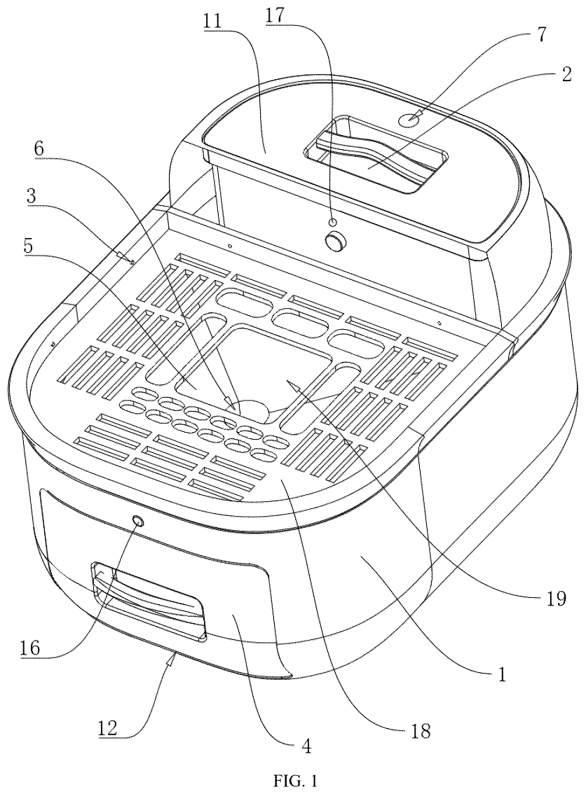

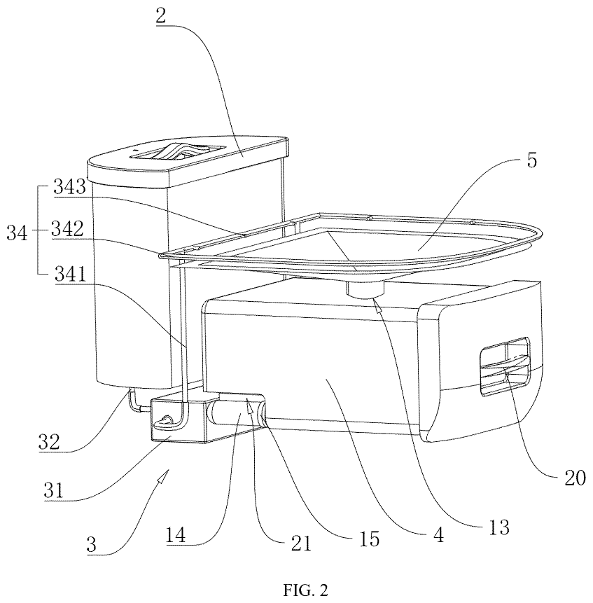

Referring to FIG. 1 to FIG. 5, as shown in FIG. 1 and FIG. 2, a portable smart pet toilet includes a toilet housing 1, a clean water tank 2, a clean water delivery system 3, a waste water tank 4, and a sensing system. A potty 5 is disposed outside the toilet housing 1. A first communicating hole 6 is formed in a bottom of the potty 5. The clean water tank 2 is disposed inside the toilet housing 1 and configured to store clean water. The clean water delivery system 3 is configured to deliver clean water in the clean water tank 2 into the potty 5. The waste water tank 4 is disposed inside the toilet housing 1 and is in communication with the potty 5 by using the first communicating hole 6. The sensing system is disposed in the toilet housing 1 and controlled to be connected to the clean water delivery system 3, and the sensing system is configured to sense a pet located in the potty 5. When the pet enters the potty 5 for excretion, the sensing system detects the presence of the pet, and sends a signal to the clean water delivery system 3 after confirming an excretion behavior of the pet. After receiving the signal, the clean water delivery system 3 delivers the clean water stored in the clean water tank into the potty 5, so that pet excreta flows into the waste water tank 4 by using the first communicating hole 6 under covering and flushing effects of the clean water, to complete the process that the pet goes to the toilet and the excreta is flushed immediately. Compared with traditional pet toilets, the pet excreta can be quickly covered and flushed into the closed waste water tank 4 through instant flushing, which can greatly reduce indoor emission of peculiar smell and keeps the potty 5 clean in a wet flushing manner, thereby reducing an opportunity of breeding pathogenic bacteria, and improving indoor environment quality. Moreover, without regularly manual cleaning, by using functions of automatic flushing and waste water collection, frequency and strength of manual cleaning are reduced. In addition, the use of cat litter can be avoided, so as to reduce pet feeding costs.

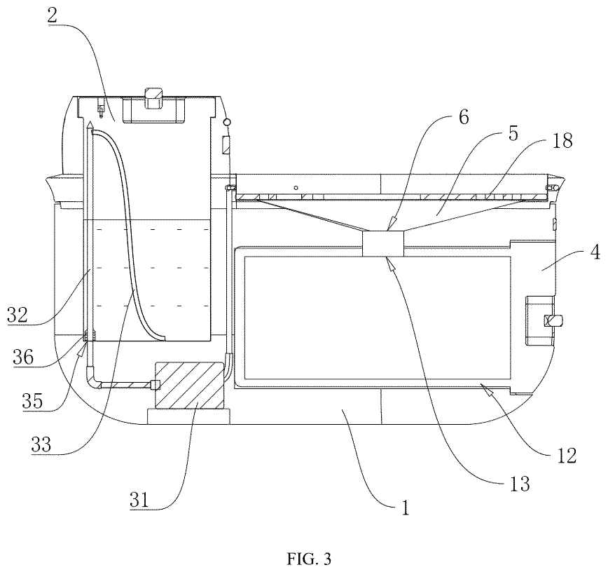

As shown in FIG. 2 and FIG. 3, the water delivery system 3 includes a water pump 31, a connecting pipe 32, a pumping pipe 33, and a delivery pipe 34. The water pump 31 is disposed inside the toilet housing 1. A connecting hole 35 for the connecting pipe 32 to penetrate through is formed in the clean water tank 2. The clean water tank 2 is coaxially provided with a waterproof sealing ring 36 at the connecting hole 35. The connecting pipe 32 is vertically disposed inside the clean water tank 2 by using the connecting hole 35 and the waterproof sealing ring 36. A bottom of the clean water tank 2 is in communication with the water pump 31. One end of the pumping pipe 33 is in communication with a top of the connecting pipe 32, and the other end of the pumping pipe 33 is located at the bottom inside the clean water tank 2. The delivery pipe 34 is disposed inside the toilet housing 1. One end of the delivery pipe 34 is in communication with the water pump 31, and the other end of the delivery pipe 34 is disposed in the potty 5. During working, the sensing system sends a signal to the water pump 31 to start the water pump 31 after sensing that the pet goes to the toilet. The clean water is pumped from the bottom of the clean water tank 2 by using the pumping pipe 33, and the clean water is delivered to the water pump 31 by using the connecting pipe 32. Then, the clean water is delivered into the potty 5 by using the delivery pipe 34 to complete a flushing working procedure. One end of the pumping pipe 33 is located at the bottom inside the clean water tank 2, so as to make contact with the clean water inside the clean water tank 2 at any time. A delivery channel is jointly formed in cooperation with the connecting pipe 32, so that the water pump 31 can efficiently pump the clean water. Moreover, by setting the connecting hole 35, the clean water tank 2 can be disassembled from the interior of the toilet housing 1, so as to facilitate maintenance and cleaning. In addition, with the effect of the waterproof sealing ring 36, sealing performance between the clean water tank 2 and the connecting pipe 32 can be ensured to avoid a case of water leakage.

It should be noted that a filter screen (not shown in the drawings) is disposed inside the connecting pipe 32, so as to prevent a pipeline from being blocked and ensure smooth operation of the water delivery system 3.

Further, the delivery pipe 34 includes a pump pipe 341 and an annular water pipe 342. One end of the pump pipe 341 is in communication with the water pump 31, and the other end of the pump pipe 341 is in communication with the annular water pipe 342. The annular water pipe 342 is disposed around a circumference of the potty 5. A plurality of flushing capillary pipes 343 are disposed on the inner side of the annular water pipe 342. The plurality of flushing capillary pipes 343 are disposed along a circumferential direction of the annular water pipe 342 and face an inside of the potty 5. The pump pipe 341 is disposed to provide a mounting position of the communicated water pump 31 for the annular water pipe 342. The annular water pipe 342 is disposed around the circumference of the potty 5 to ensure that clean water can be evenly distributed around the potty 5. With cooperation with a plurality of water flushing capillary pipes 343 disposed along the circumferential direction of the annular water pipe 342, the clean water is covered on the pet excreta in a small, high-pressure and uniform water flow form, thereby reducing flushing dead angles and peculiar smell emission to achieve more elaborate and comprehensive flushing.

Further, pipe diameters of the pump pipe 341, the annular water pipe 342, and the flushing capillary pipe 343 successively decrease. Through the design that the pipe diameters of the pump pipe 341, the annular water pipe 342, and the flushing capillary pipe 343 successively decrease, the clean water can be gradually dispersed and refined in a delivery process. In addition, the flow rate is increased, so as to ensure that the clean water is evenly and finely sprayed inside the potty 5, thereby reducing flushing dead angles, and improving a flushing effect.

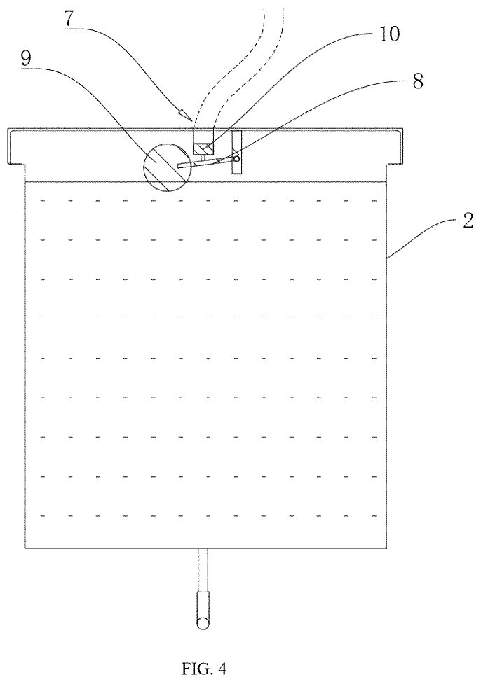

In addition, as shown in FIG. 4, a water inlet 7 is formed in the clean water tank 2. The water inlet 7 is configured to be in communication with an external water source. A linkage lever 8 is rotatably mounted inside the clean water tank 2. A floating ball 9 and a water inlet control block 10 are disposed on the linkage lever 8. A closed position exists on a rotation track of the linkage lever 8. When the linkage lever 8 rotates to the closed position, the water inlet control block 10 is in plug-in fit with the water inlet 7. When a water level in the clean water tank 2 drops, the floating ball drops with the water level and drives the linkage lever 8 to rotate downward, so as to drive the water inlet control block 10 to be separated from the water inlet 7, so that the external water source can enter the clean water tank 2 by using the water inlet 7, to complete automatic supply of clean water. When the water level rises until making contact with the floating ball, the floating ball 9 rises with the water level and drives the linkage lever 8 to rotate, so as to drive the water inlet control block 10 to rotate until at the closed position. In this way, the water inlet control block 10 is continuously in plug-in fit with the water inlet 7 under a buoyancy action of the clean water, so as to prevent water flow from continuing to enter, and complete automatic water supply blockage of clean water, thereby implementing an automatic water supply function of the clean water tank 2 and preventing occurrence of a water overflow phenomenon, greatly improving convenience of the pet toilet, improving user experience, simultaneously saving water resources and energy consumption, and meeting requirements of energy conservation and emission reduction.

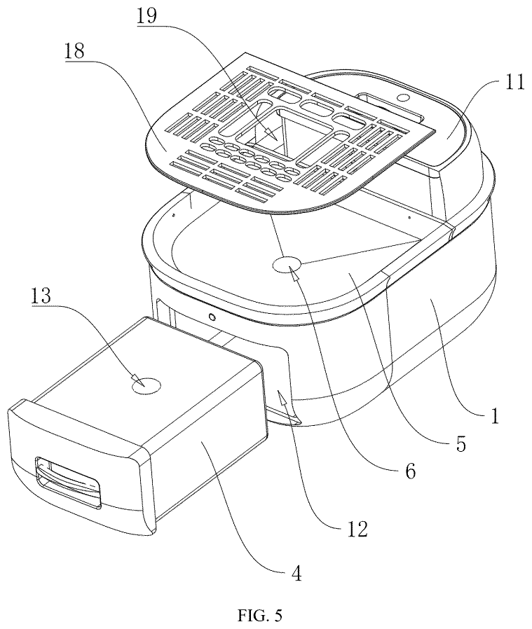

In addition, as shown in FIG. 5, to facilitate use of an external water source that is difficult to connect, in an embodiment, atop of the clean water tank 2 is open and is in lap joint with a top cover 11. By disposing the top cover 11 that can be lapped and disassembled, when the user is inconvenient to connect the external water source, the top cover 11 can be disassembled, and clean water is poured into the clean water tank to supply water.

Optionally, as shown in FIG. 2 and FIG. 5, an accommodation tank 12 configured to put the waste water tank 4 is disposed in the toilet housing 1. A top of the accommodation tank 12 is in communication with the first communicating hole 6. A second communicating hole 13 is formed in a top of the waste water tank 4. When the waste water tank 4 is located in the accommodation tank 12, the first communicating hole 6 is in communication with the second communicating hole 13, a discharge pipe 14 is in communication with an outside of the waste water tank 4. A cover 15 is buckled at an open end of the discharge pipe 14. The accommodation tank 12 provides a mounting position for the waste water tank 4 inside the toilet housing 1. When the waste water tank 4 is located inside the accommodation tank 12, the first communicating hole 6 of the potty 5 is aligned to and is in communication with the second communicating hole 13 at the top of the waste water tank 4, to form a smooth discharge channel. In addition, in cooperation with the discharge pipe 14 outside the waste water tank 4, after water at an appointed water level in the waste water tank 4 is collected, the waste water tank 4 can be taken out directly. The pet excreta is discharged into the external environment by using the discharge pipe 14, and the cover 15 is disposed, so that sealing performance of the discharge pipe 14 can be ensured when the excreta is not discharged.

In some embodiments, an opening in communication with the outside is formed in a side wall of the accommodation tank 12, and the waste water tank 4 can enter and move out of the accommodation tank 12 by using the opening; and a handle is disposed on a side exposed to the waste water tank 4. By setting the opening, the waste water tank 4 can directly enter the accommodation tank 12 and be drawn out of the accommodation tank 12, so that the waste water tank 4 is convenient to clean.

In some embodiments, the waste water tank 4 includes a tank body and a connecting portion connected to the tank body, and an edge of the connecting portion projects on an edge of the tank body to form a limit boss; and when the waste water tank 4 is mounted in the accommodation tank 12, the limit boss is clamped to an inside wall of the accommodation tank 12. In this embodiment, the limit boss is clamped to the accommodation tank 12, so that the waste water tank 4 mounted in the accommodation tank 12 is mounted stably, and is not prone to be loosened due to a false touch.

In some embodiments, the potty 5 is gradually recessed from the circumference to the middle, and the first communicating hole 6 is located at the bottom of the potty 5. A communicating pipe is disposed outside the potty 5 corresponding to the first communicating hole 6, and the second communicating hole 13 is located under the connecting pipe. The second communicating hole 13 is in communication with an end of the communicating pipe away from the first communicating hole 6. In this embodiment, the communicating pipe is mounted at the bottom of the potty 5, and is corresponding to the second communicating hole 13, so that waste water can enter the waste water tank 4 by using the communicating pipe, and does not hinder movement of the waste water tank 4. The waste water tank 4 is conveniently and smoothly drawn out of the accommodation tank 12.

In some embodiments, the discharge pipe is in communication with a bottom of the waste water tank 4, and when the waste water tank 4 is mounted in the accommodation tank 12, the second communicating hole 13 is in communication with an external environment by using the first communicating hole 6. In this case, the waste water tank 4 is in communication with an external environment by using a single hole, which is not conducive to gas flow. In this way, gas in the waste water tank 4 is inconvenient to be in direct communication with gas outside the waste water tank 4, so as to avoid odor in the waste water tank 4 to be emitted to surrounding environments as far as possible.

In some embodiments, the clean water tank 2 is located in an upward extension direction of the opening, so that a direction of taking out the waste water tank 4 is consistent with a length direction of the portable smart pet toilet. For example, when the length direction of the portable smart pet toilet is in a front-to-back direction, the clean water tank 2 is disposed in a rear position, the waste water tank 4 is disposed in a front position, and the waste water tank 4 is taken out and assembled in a front-to-back direction. In this way, the direction of taking out the waste water tank 4 is consistent with the length direction of the portable smart pet toilet, so that when the pet toilet is used, required space is strip-shaped, and strip-shaped space may be well matched.

It should be noted that the handle 20 is disposed on the waste water tank 4, so that the waste water tank 4 is convenient for the user to pull out. A buckle locking structure (not shown in the drawings) may be disposed between the waste water tank 4 and the accommodation tank 12, so that the waste water tank 4 is convenient for the user to lock, and mounting stability of the waste water tank 4 is improved. The buckle locking structure may be a pressing locking structure, a magnetic locking structure, and the like that are commonly used on the market, and is not limited herein. In this embodiment, an avoidance slot 21 configured to put the discharge pipe 14 is formed in the bottom of the waste water tank 4, and the discharge pipe 14 is in communication with the waste water tank 4 in a rotational connection manner. When the waste water tank 4 needs to be mounted, the discharge pipe 14 rotates into the avoidance slot 21, so that the waste water tank 4 is mounted inside the accommodation tank 12. When the waste water tank 4 is drawn out, the discharge pipe 14 rotates to the outside of the waste water tank 4, so that the waste water is convenient to discharge by using the discharge pipe 14.

Further, as shown in FIG. 1, a sensing indicator lamp 16 is disposed in the toilet housing 1. A water level monitor (not shown in the drawing) is mounted in the waste water tank 4. The water level monitor is controlled to be connected to the sensing indicator lamp 16 and the clean water delivery system 3. The water level monitor can monitor a water level change inside the waste water tank 4 in real time. After monitoring that the water level in the waste water tank 4 reaches a preset threshold, the water level monitor can send a signal to the sensing indicator lamp 16, so that the sensing indicator lamp 16 is lit up or a color changes, so as to remind the user of cleaning the waste water tank 4 in time. Moreover, the water level monitor can send a signal to the clean water delivery system 3, so as to stop any form of flushing to avoid the waste water from overflowing, thereby improving convenience of the pet toilet.

Optionally, the sensing system includes an infrared heat sensor 17 and a control panel (not shown in the drawing). The infrared heat sensor 17 is disposed in a position inside the toilet housing 1 and close to the potty 5. The control panel is controlled to be connected to the infrared heat sensor 17 and the water pump 31. When the pet goes to the toilet, the infrared heat sensor 17 can sense a pet located on the potty 5, and the signal is sent to the control panel, so as to start the water pump 31 to work. In addition, the water pump 31 can be further started again to work after the pet leaves away for a short time based on a preset program of the control panel, so as to avoid from disturbing the pet when the pet goes to the toilet.

In some embodiments, according to the portable smart pet toilet according to claim 1, the clean water delivery system 3 includes a water pump 31, a connecting pipe 32, a pumping pipe 33, and a delivery pipe 34. The water pump 31 is disposed inside the toilet housing 1. The delivery pipe 34 includes a pump pipe 341 and an annular water pipe 342. One end of the pump pipe 341 is in communication with the water pump 31, and the other end of the pump pipe 341 is in communication with the annular water pipe 342. The annular water pipe 342 is disposed around a circumference of the potty 5. A plurality of flushing capillary pipes 343 are in communication with the inner side of the annular water pipe 342. The plurality of flushing capillary pipes 343 are disposed along a circumferential direction of the annular water pipe 342 and face an inside of the potty 5. In this embodiment, the annular water pipe 342 is disposed around the circumference of the potty 5, and the flushing capillary pipes 342 are arranged in the circumferential direction of the potty 5, so that the flushing capillary pipes 342 may flush waste on the circumference of the potty 5 toward the middle of the potty 5. In addition, because the middle of the potty 5 is relatively low, under the action of gravity, water and waste flow to the first communicating hole 6 in the middle of the potty 5. In this way, the waste can be discharged into the waste water tank 4 smoothly and efficiently by using the first communicating hole 6 with water flushing.

In some embodiments, a partition plate 18 configured to support a pet is mounted in the potty 5, and a plurality of discharge holes 19 are formed in the partition plate 18; and the flushing capillary pipes 342 are located above the partition plate 18, so that the flushing capillary pipes 342 can flush an upper surface of the partition plate 18. In this embodiment, the flushing capillary pipes 342 are disposed above the partition plate 18, so that water ejected from the flushing capillary pipes 342 may be ejected to the upper surface of the partition plate 18, so that cat excreta on the upper surface of the partition plate 18 may be flushed into the potty 5 by using the discharge hole 19. Therefore, regardless of where the cat is on the partition plate 18, the water ejected by the flushing capillary pipes 342 may be washed into the potty 5.

In some embodiments, an area of the discharge hole 19 in the middle of the partition plate 18 is greater than an area of a discharge hole 19 in an edge of the partition plate 18, so that the flushing capillary pipes 342 around the partition plate 18 can flush waste with a large volume on the edge of the partition plate 18 into the discharge hole 19 in the middle. In this embodiment, the discharge hole 19 with a large area in the middle area of the partition plate 18 is a normal discharge channel for the cat, and the discharge holes 19 with small areas in a peripheral area are discharge channels when a position of the cat is not accurate enough. When the volume of cat excreta is large and is located on the edge of the partition plate 18, the cat excreta may be water sprayed by the flushing capillary 342 may be dispersed by water ejected from the flushing capillary pipes 342 and discharged by using the discharge holes 19 with small areas, or may be flushed to the discharge hole 19 in the middle for discharge. In this way, combination of the discharge holes 19 of different sizes can not only satisfy normal excretion of the cat (the cat excreta is discharged in the middle of the partition plate 18), but also meet a special condition (the cat excreta is discharged in the edge of the partition plate 18).

Optionally, as shown in FIG. 1 and FIG. 5, a partition plate 18 configured to support a pet is mounted in the potty 5. A plurality of discharge holes 19 are formed in the partition plate 18. Sizes of the plurality of discharge holes 19 gradually increase from an outside of the partition plate 18 to a center of the partition plate 18. By setting the partition plate 18, a support position can be provided for the pet when the pet goes to the toilet. By setting a plurality of discharge holes 19, it is ensured that after the pet is excreted on the partition plate 18, the excreta can be smoothly dropped into the lower waste water tank 4 by using the discharge hole 19, and cleaning of the partition plate 18 is completed under the action of the clean water delivery system 3. By setting the plurality of discharge holes 19 gradually increasing from the outer side of the partition plate 18 to the center of the partition plate, when the pet goes to the toilet, a smaller position of the discharge hole 19 on the partition plate 18 can provide a good standing position for the pet, which may guide the pet to stand in a position on the outer side of the partition plate 18 close to the discharge hole 19 with a smaller size and then to be excreted at the discharge hole 19 with a larger size, so as to improve a comfort level when the pet goes to the toilet and improve acceptability of the pet for the pet toilet.

An implementation principle of a portable smart pet toilet in this embodiment of the present disclosure is as follows. When detecting that the pet goes to the toilet at the potty 5, the infrared heat sensor 17 sends a signal to the control panel. Then, the control panel controls the water pump 31 to start. The clean water is pumped out from the clean water tank 2, and is sprayed to the potty 5 and the partition plate 18 from the pump pipe 341 and the annular water pipe 342 to the flushing capillary pipes 343. The excreta is guided into the waste water tank 4 to complete flushing. Moreover, when the sensing indicator lamp 16 is lit up or a color changes, the user can be reminded of opening the cover 15 to discharge the waste water by pumping the waste water tank 4, so as to complete the work of clearing the waste water tank 4 and ensure sanitation and normal use of the pet toilet.

The portable smart pet toilet according to the embodiments of the present disclosure has the following beneficial effects compared with traditional pet toilets.

Firstly, a valve apparatus system of an existing flushing toilet is improved. A combination of the floating ball 9, the water inlet control block 10, and the water inlet 7 implements small-volume and lightweight installation of the clean water tank 2, thereby reducing space waste of the tank body and increasing space utilization.

Secondly, the design of flushing pipelines is improved. By using a stage-by-stage pressurized pipeline design of the water pump 31, the pump pipe 341, the annular water pipe 342, and the flushing capillary pipe 343, water resources are saved while high-efficiency cleaning is achieved.

Thirdly, a convenient-to-disassemble split toilet structure can be formed by the clean water tank 2, the waste water tank 4, the toilet housing 1, and the potty 5. The toilet is convenient to carry, is adapt to use at any site, and is not limited by the site. The user can directly supply water to the top cover 11 of the clean water tank 2 to complete water supply.

Fourthly, compared with traditional dry cat litter boxes on the market, the toilet achieves a smell-free effect in a wet clean manner, and is low in pet feeding costs and convenient to create a cleaner environment.

Lastly, the pet excreta is cleaned and collected fully automatically, and the sensing indicator lamp and the water level monitor are cooperatively used to intelligently remind the user of cleaning the waste water tank, thereby greatly reducing labor pressure of the user and improving use experience of the user.

The foregoing specific implementations are not intended to limit the protection scope of the present disclosure. A person skilled in the art should understand that various modifications, combinations, sub-combinations and substitutions can be made according to design requirements and other factors. Any modification, equivalent replacement, or improvement made without departing from the spirit and principle of the present disclosure shall fall within the protection scope of the present disclosure.

What is claimed is:

1. A portable smart pet toilet, comprising:
a toilet housing, wherein a potty is disposed outside the toilet housing, and a first communicating hole is formed in a bottom of the potty;
a clean water tank, wherein the clean water tank is disposed inside the toilet housing and configured to store clean water;
a clean water delivery system, wherein the clean water delivery system is configured to deliver clean water in the clean water tank into the potty;
a waste water tank, wherein the waste water tank is disposed inside the toilet housing and is in communication with the potty by using the first communicating hole; and
a sensing system, wherein the sensing system is disposed in the toilet housing and controlled to be connected to the clean water delivery system, and the sensing system is configured to sense a pet located in the potty.

2. The portable smart pet toilet according to claim 1, wherein the water delivery system comprises a water pump, a connecting pipe, a pumping pipe, and a delivery pipe,
the water pump is disposed inside the toilet housing, a connecting hole for the connecting pipe to penetrate through is formed in the clean water tank, the clean water tank is coaxially provided with a waterproof sealing ring at the connecting hole, the connecting pipe is vertically disposed inside the clean water tank by using the connecting hole and the waterproof sealing ring, a bottom of the clean water tank is in communication with the water pump, one end of the pumping pipe is in communication with a top of the connecting pipe, the other end of the pumping pipe is located at the bottom inside the clean water tank, the delivery pipe is disposed inside the toilet housing, one end of the delivery pipe is in communication with the water pump, and the other end of the delivery pipe is disposed in the potty.

3. The portable smart pet toilet according to claim 2, wherein the delivery pipe comprises a pump pipe and an annular water pipe,
one end of the pump pipe is in communication with the water pump, the other end of the pump pipe is in communication with the annular water pipe, the annular water pipe is disposed around a circumference of the potty, a plurality of flushing capillary pipes are in communication with the inner side of the annular water pipe, and the plurality of flushing capillary pipes are disposed along a circumferential direction of the annular water pipe and face an inside of the potty.

4. The portable smart pet toilet according to claim 3, wherein pipe diameters of the pump pipe, the annular water pipe, and the flushing capillary pipe successively decrease.

5. The portable smart pet toilet according to claim 1, wherein a water inlet is formed in the clean water tank, the water inlet is configured to be in communication with an external water source, a linkage lever is rotatably mounted inside the clean water tank, a floating ball and a water inlet control block are disposed on the linkage lever, a closed position exists on a rotation track of the linkage lever, and when the linkage lever rotates to the closed position, the water inlet control block is in plug-in fit with the water inlet.

6. The portable smart pet toilet according to claim 1, wherein a top of the clean water tank is open and is in lap joint with a top cover.

7. The portable smart pet toilet according to claim 1, wherein an accommodation tank configured to accommodate the waste water tank is disposed in the toilet housing, a top of the accommodation tank is in communication with the first communicating hole, a second communicating hole is formed in a top of the waste water tank, and when the waste water tank is located in the accommodation tank, the first communicating hole is in communication with the second communicating hole, a discharge pipe is in communication with an outside of the waste water tank, and a cover is buckled at an open end of the discharge pipe.

8. The portable smart pet toilet according to claim 1, wherein a sensing indicator lamp is disposed in the toilet housing, a water level monitor is mounted in the waste water tank, and the water level monitor is controlled to be connected to the sensing indicator lamp and the clean water delivery system.

9. The portable smart pet toilet according to claim 2, wherein the sensing system comprises an infrared heat sensor and a control panel, the infrared heat sensor is disposed in a position inside the toilet housing and close to the potty, and the control panel is controlled to be connected to the infrared heat sensor and the water pump.

10. The portable smart pet toilet according to claim 1, wherein a partition plate configured to support a pet is mounted in the potty, a plurality of discharge holes are formed in the partition plate, and sizes of the plurality of discharge holes gradually increase from an outside of the partition plate to a center of the partition plate.

11. The portable smart pet toilet according to claim 7, wherein an opening in communication with the outside is formed in a side wall of the accommodation tank, and the waste water tank is able to enter and move out of the accommodation tank by using the opening; and
a handle is disposed on a side exposed to the waste water tank.

12. The portable smart pet toilet according to claim 11, wherein the waste water tank comprises a tank body and a connecting portion connected to the tank body, and an edge of the connecting portion projects on an edge of the tank body to form a limit boss; and
when the waste water tank is mounted in the accommodation tank, the limit boss is clamped to an inside wall of the accommodation tank.

13. The portable smart pet toilet according to claim 11, wherein the potty is gradually recessed from the circumference to the middle, and the first communicating hole is located at the bottom of the potty;
a communicating pipe is disposed outside the potty corresponding to the first communicating hole, and the second communicating hole is located under the connecting pipe; and
the second communicating hole is in communication with an end of the communicating pipe away from the first communicating hole.

14. The portable smart pet toilet according to claim 11, wherein the discharge pipe is in communication with a bottom of the waste water tank, and when the waste water tank is mounted in the accommodation tank, the second communicating hole is in communication with an external environment by using the first communicating hole.

15. The portable smart pet toilet according to claim 11, wherein the clean water tank is located in an upward extension direction of the opening, so that a direction of taking out the waste water tank is consistent with a length direction of the portable smart pet toilet.

16. The portable smart pet toilet according to claim 1, wherein the clean water delivery system comprises a water pump, a connecting pipe, a pumping pipe, and a delivery pipe, and the water pump is disposed inside the toilet housing; and
the delivery pipe comprises a pump pipe and an annular water pipe, one end of the pump pipe is in communication with the water pump, the other end of the pump pipe is in communication with the annular water pipe, the annular water pipe is disposed around a circumference of the potty, a plurality of flushing capillary pipes are in communication with the inner side of the annular water pipe, and the plurality of flushing capillary pipes are disposed along a circumferential direction of the annular water pipe and face an inside of the potty.

17. The portable smart pet toilet according to claim 16, wherein a partition plate configured to support a pet is mounted in the potty, and a plurality of discharge holes are formed in the partition plate; and
the flushing capillary pipes are located above the partition plate, so that the flushing capillary pipes are able to flush an upper surface of the partition plate.

18. The portable smart pet toilet according to claim 17, wherein an area of the discharge hole in the middle of the partition plate is greater than an area of a discharge hole in an edge of the partition plate, so that the flushing capillary pipes around the partition plate are able to flush waste with a large volume on the edge of the partition plate into the discharge hole in the middle.
